(19) United States
(12) Patent Application Publication
(10) Pub. No.: US 2015/0083521 A1
(43) Pub. Date: Mar. 26, 2015

(54) METHOD AND APPARATUS FOR LADDER SHOULDER REST

(71) Applicant: Jess Foddrill, Pine Bush, NY (US)

(72) Inventor: Jess Foddrill, Pine Bush, NY (US)

(21) Appl. No.: 14/465,861

(22) Filed: Aug. 22, 2014

Related U.S. Application Data
(60) Provisional application No. 61/880,876, filed on Sep. 21, 2013.

(51) Int. Cl. E06C 7/00; A41D 31/00

(52) U.S. Cl. CPC E06C 7/00; A41D 31/0044
USPC 182/129; 29/525; 428/57

(57) ABSTRACT

A method and/or apparatus which alleviates the discomfort in carrying ladders of all kinds, particularly metal ladders. A device including a first section which has a first slot, and a second section having a second slot is provided. The first section may be attached to the second section so that the first section is substantially at a right angle with respect to the second section. The first and the second slots may meet at a first junction. The first and the second sections may be made of an elastic material. The apparatus may include a ladder having first and second posts joined by a plurality of steps including a first step. A part of the first step of the ladder may fit into the first slot of the first section while simultaneously a part of the first post may fit into the second slot of the second section.

### CROSS REFERENCE TO RELATED APPLICATION(S)

The present application claims the priority of U.S. provisional patent application Ser. No. 61/880,876, titled “LADDER SHOULDER SAVER”, filed on Sep. 21, 2013.

### FIELD OF THE INVENTION

This invention relates to improved methods and apparatus concerning ladders.

### BACKGROUND OF THE INVENTION

Anyone carrying a step ladder or extension ladder for short or long periods know the pain caused on the shoulder with the metal edges bearing down on the shoulder. The prior art does not solve this problem.

### SUMMARY OF THE INVENTION

One or more embodiments of the present invention provides a method and/or apparatus which alleviates the discomfort in carrying ladders of all kinds, particularly metal ladders.

One or more embodiments of the present invention provide an apparatus comprising a device including a first section which has a first slot; and a second section having a second slot. The first section may be attached to the second section so that the first section is substantially at a right angle with respect to the second section. The first slot and the second slot may meet at a first junction. The first section and the second section may be made of an elastic material.

The apparatus may include a ladder having first and second posts joined by a plurality of steps including a first step. A part of the first step of the ladder may fit into the first slot of the first section while at the same time a part of the first post may fit into the second slot of the second section. The first and the second section may be joined together at a second junction; and the second junction may have an inner surface which is curved.

In at least one embodiment a method is provide which includes attaching a first device to a ladder. The first device may be a device as previously described. A second device and a plurality of further devices may be attached in a similar manner or an identical manner to the first device.

### BRIEF DESCRIPTION OF THE DRAWINGS

FIG. 1A shows a rear, top, and right side perspective view of an apparatus in accordance with an embodiment of the present invention;

FIG. 1B shows a front, top, and right side perspective view of the apparatus of FIG. 1A;

FIG. 1C shows a front, bottom, and left side perspective view of the apparatus of FIG. 1A;

FIG. 1D shows a rear, bottom, and left side perspective view of the apparatus of FIG. 1A;

FIG. 1E shows a front, top, and left side perspective view of the apparatus of FIG. 1A;

FIG. 1F shows a rear, top, and left side perspective view of the apparatus of FIG. 1A;

FIG. 2A shows a front view of the apparatus of FIG. 1A;

FIG. 2B shows a rear view of the apparatus of FIG. 1A;

FIG. 2C shows a bottom view of the apparatus of FIG. 1A;

FIG. 2D shows a top view of the apparatus of FIG. 1A;

FIG. 2E shows a left side view of the apparatus of FIG. 1A;

FIG. 2F shows a right side view of the apparatus of FIG. 1A;

FIG. 3A shows a front, top, and left side perspective view of the apparatus of FIG. 1A next to a ladder, with the apparatus of FIG. 1A not attached to the ladder;

FIG. 3B shows a front, top, and left side perspective view of the apparatus of FIG. 1A attached to the ladder of FIG. 3A;

FIG. 3C shows a front, top, and left side perspective view of the ladder of FIG. 3A and a rear top and right side view of the apparatus of FIG. 1A, with the apparatus of FIG. 1A attached to the ladder of FIG. 3A;

FIG. 4A shows a front, top, and left side perspective view of another ladder for use with an embodiment of the present invention;

FIG. 4B shows a top view of a post portion of the ladder of FIG. 4A;

FIG. 4C shows a bottom view of a step portion of the ladder of FIG. 4A;

FIG. 4D shows a top view of a first further insert inserted into a gap or recess of the post portion of the ladder of FIG. 4A;

FIG. 4E shows a bottom view of a second further insert inserted into a gap or recess of the step portion of the ladder of FIG. 4A; and

FIG. 4F shows a front, top, and left side perspective view of the ladder of FIG. 4A with the first further insert and the second further insert of FIGS. 4D and 4E respectively attached to the ladder of FIG. 4A.

### DETAILED DESCRIPTION OF THE DRAWINGS

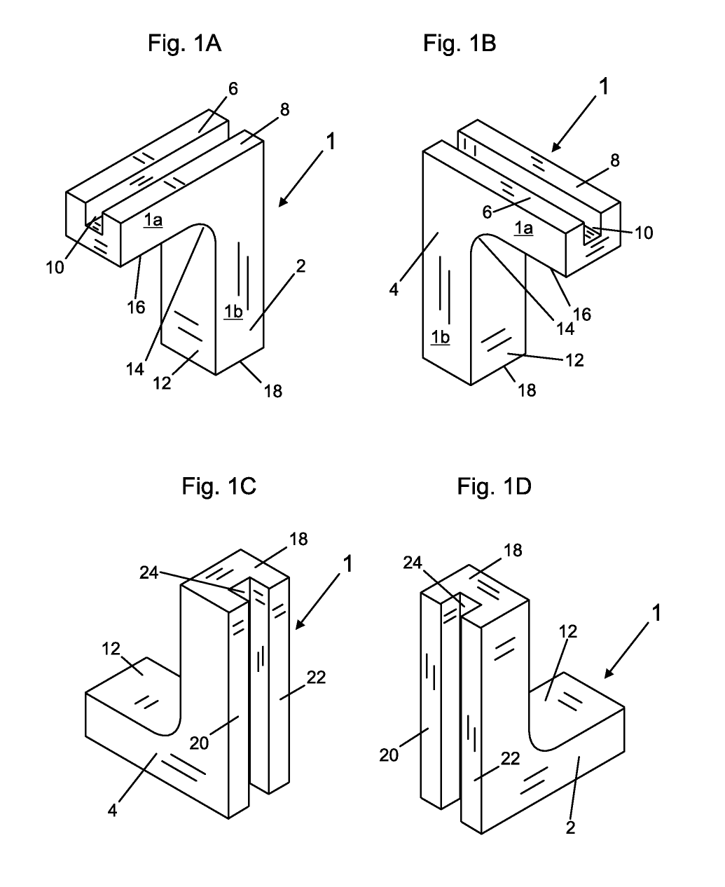

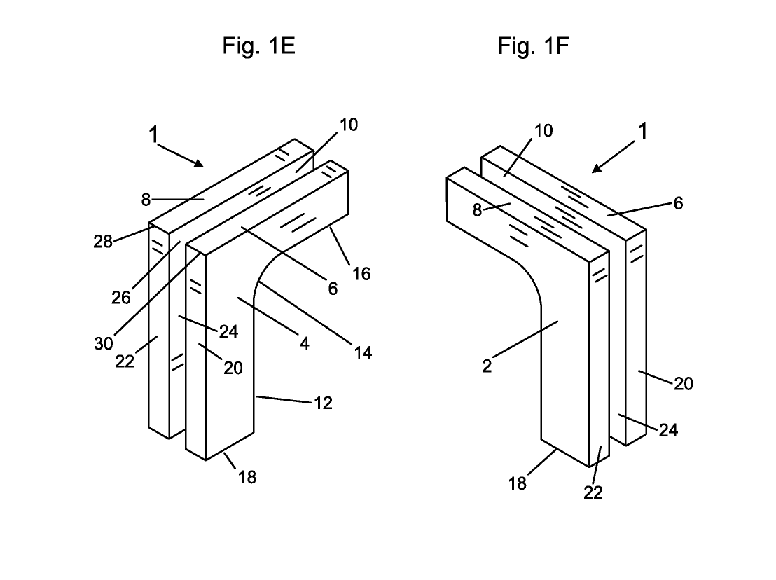

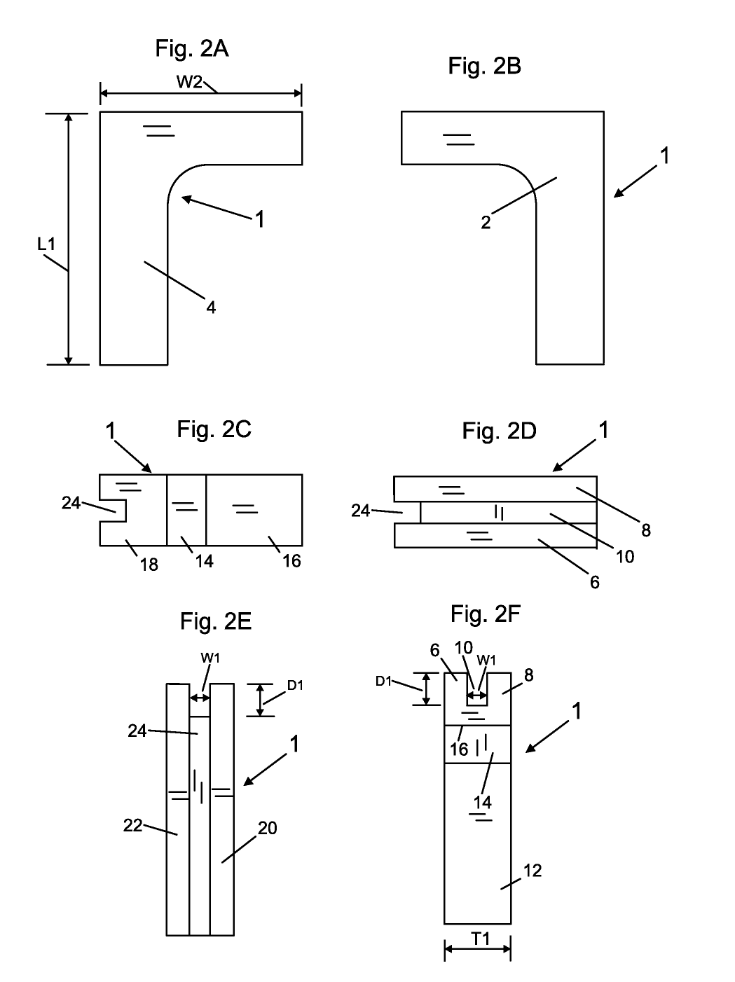

FIG. 1A shows a rear, top, and right side perspective view of an apparatus 1 in accordance with an embodiment of the present invention. FIG. 1B shows a front, top, and right side perspective view of the apparatus 1. FIG. 10 shows a front, bottom, and left side perspective view of the apparatus 1. FIG. 1D shows a rear, bottom, and left side perspective view of the apparatus 1. FIG. 1E shows a front, top, and left side perspective view of the apparatus 1. FIG. 1F shows a rear, top, and left side perspective view of the apparatus 1. FIGS. 2A-2F show front, rear, bottom, top, left side, and right side views, respectively of the apparatus 1.

The apparatus 1 may be a solid, one piece object made of polyurethane rubber or some other elastomeric material. The apparatus 1 may the described as being comprised of a first section 1a and a second section 1b, which are at a right angle or a substantially at a right angle with respect to each other, as shown in FIGS. 1A-B. The apparatus 1 may also be described as being L-shaped. Referring to FIGS. 1A-2F, the apparatus 1 may include a rear surface 2, a front surface 4, first and second rails or protrusions 6 and 8, a slot 10 between rails 6 and 8, a flat surface 12, a curved surface 14, a flat surface 16, a bottom surface 18, rails or protrusions 20 and 22, and a slot 24. The slots 10 and 24 come together at junction 26, so that there is effectively a continuous slot comprised of slots 10 and 24. The rails 8 and 22 come together at junction 28, so that there is effectively a continuous railing comprised of railings 8 and 22. The rails 6 and 20 come together at junction 30, so that there is effectively a continuous railing comprised of railings 6 and 20.

In at least one embodiment, the apparatus 1 may be formed out of one piece of injected molded neoprene rubber or such related material. Each of the slots 10 and 24 may have a width W1, which may be ¼ of an inch, as shown by FIGS. 2E and 2F. Each of the slots 10 and 24 may have a depth D1, which may be ¾ of an inch, as shown by FIGS. 2E and 2F. The apparatus 1 may have an overall length L1, which may be about twelve inches and an overall width D2, which may be about twelve inches as shown in FIG. 2A. The apparatus 1 may have an overall thickness, T1, which may be four inches, as shown in FIG. 2F. The dimensions of the apparatus 1 may be changed depending on the application.

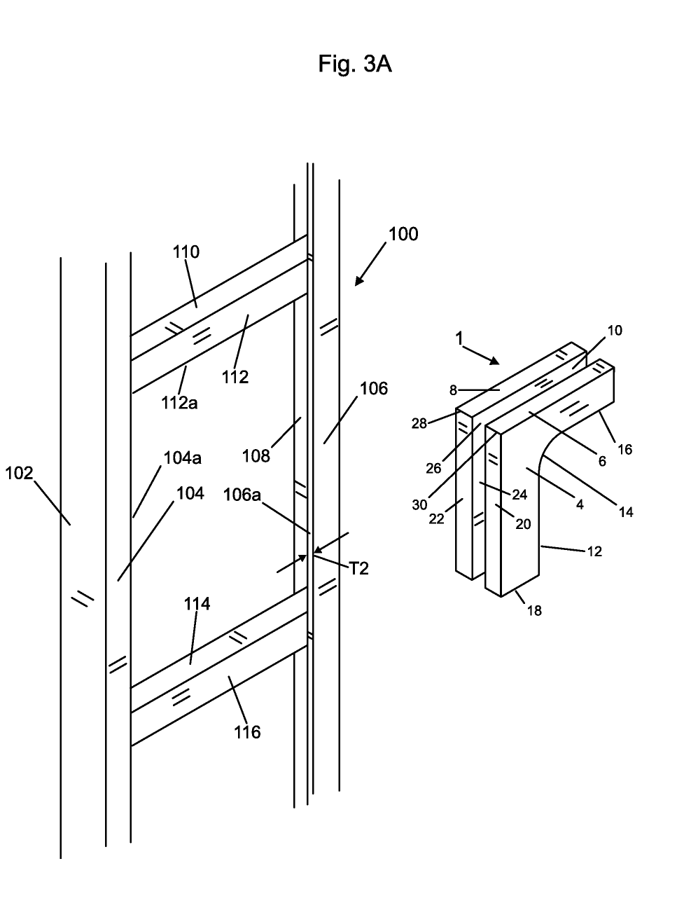

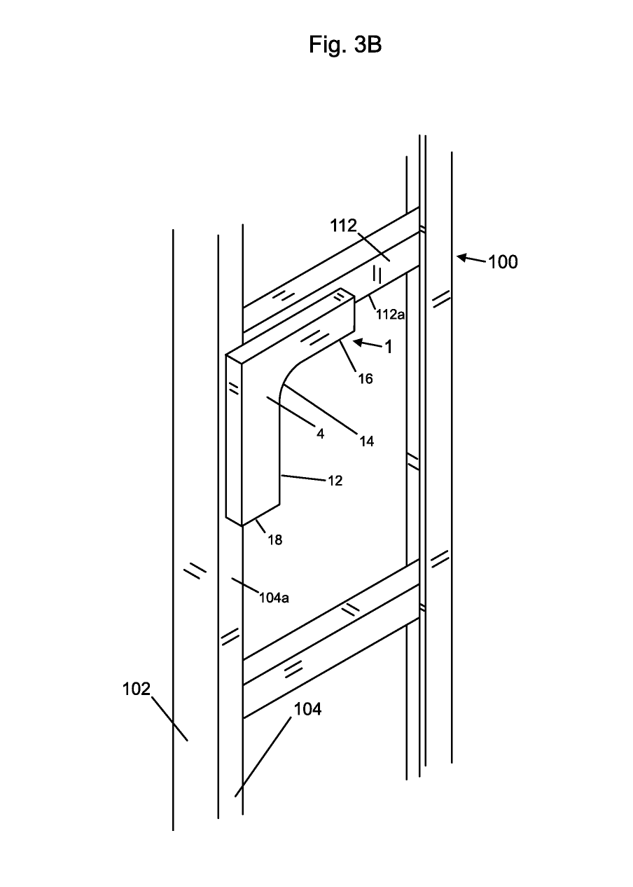

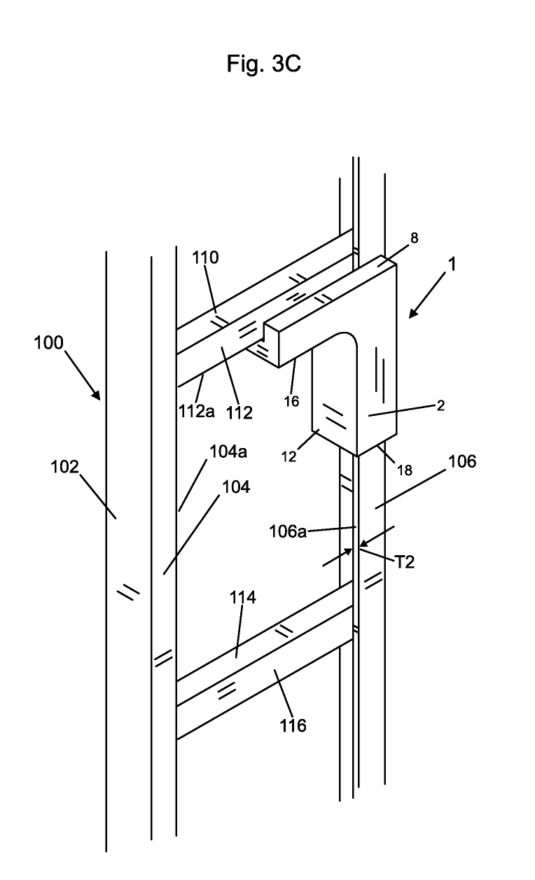

FIG. 3A shows a front, top, and left side perspective view of the apparatus 1 next to a ladder 100, with the apparatus 1 not attached to the ladder 100. The ladder 100 may be a known ladder such as a metal ladder. The ladder 100 may include a plates 102 and 104 which are at attached at a right angle to one another to form one post and plates 106 and 108 which are attached at a right angle to one another to form a second post. The post formed by plates 102 and 104 is connected to the post formed by plates 106 and 108 by a plurality of plates, such as plates 110, 112, 114, and 116. The plates 110 and 112 are connected at a right angle to one another and plate 110 is used by an individual to step on with his or her foot to go up the ladder 100. The plates 114 and 116 are connected at a right angle to one another and plate 114 is used by an individual to step on with his or her foot to go up the ladder 100.

The plate 112 has an edge 112a having a thickness T2, shown in FIG. 3A. The plates 104 and 106 have edges 104a and 106a, respectively, having a thickness T2, shown in FIG. 3A. The combination of the thickness of the plate 112 and the plate 106 (two times T2), in at least one embodiment, is less than the width W1 of the slots 10 and 24 of the apparatus 1, shown in FIGS. 2E and 2F. This allows the apparatus 1 to be attached to the ladder 100 as in FIG. 3B so that part of the plate 112 and part of the plate 104 fits into the slots 10 and/or 24 of the apparatus 1. Alternatively, the width W1 of the slots 10 and 24, shown in FIGS. 2E and 2F may be slightly smaller than the combined thickness of the plate 112 and the plate 104, and the apparatus 1 may be made of an elastic material which deforms to allow attachment of the apparatus 1 to the ladder 100 as in FIG. 3B. Alternatively, the width W1 of the slots 10 and 24, may be slightly smaller or slightly larger than the thickness of plate 112 by itself (i.e. T2), if the ladder 100 is constructed so that plate 112 does not overlap plate 104.

FIG. 3C shows a front, top, and left side perspective view of the ladder 100 of FIG. 3A and a rear top and right side view of the apparatus 1 of FIG. 1A, with the apparatus 1 of FIG. 1A attached to the ladder 100, such that the plates 106 and 112 are inserted into the slots 10 and 24. The apparatus 1 slips onto the plates 112 and 104 or onto plates 112 and 106 of the ladder 100 to provide a cushion between a human's shoulder and the metal plates 112 and 106. This allows someone to carry ladder 100 without hurting their shoulder, and also if the ladder 100 slips downwards, the cushion or apparatus 1 protects the person's shoulder.

In at least one embodiment, an adhesive is placed in the slot 10 between the rails 6 and 8, and in the slot 24 between the rails 20 and 22. The adhesive may be placed both on the bottom of the U-shaped slots 10 and 24 and on the sides of the U-shaped slots 10 and 24. Removable cover papers may be placed over both the U-shaped slots 10 and 24. The removable cover papers may be removed and the apparatus 1 may be attached to the ladder 100 as in FIGS. 3B and/or 3C. A plurality of apparatuses 1 may be provided to attach to all corner areas of ladder 100 or other ladder. For example, for the ladder or ladder portion 100 in FIGS. 3A-3C, four apparatuses 1 may be provded and attached to ladder 100 for the corner formed by plates 112 and 106, the corner formed by plates 112 and 104, the corner formed by plates 116 and 106, and the corner formed by plates 116 and 104.

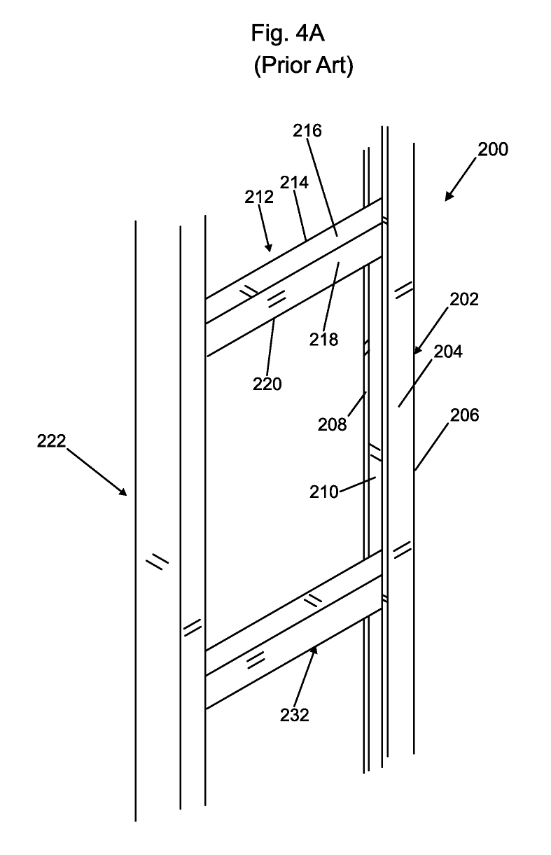

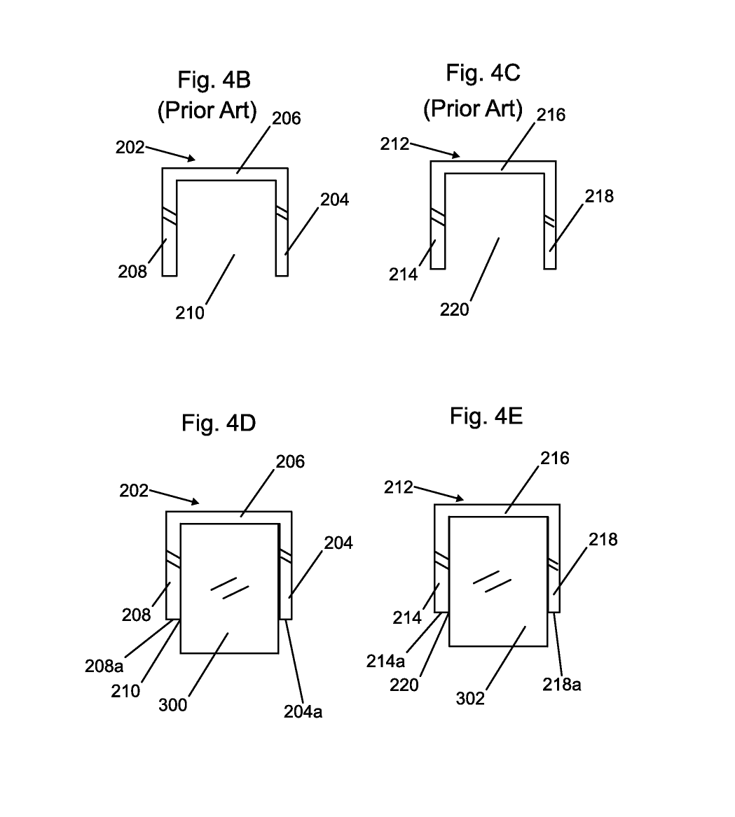

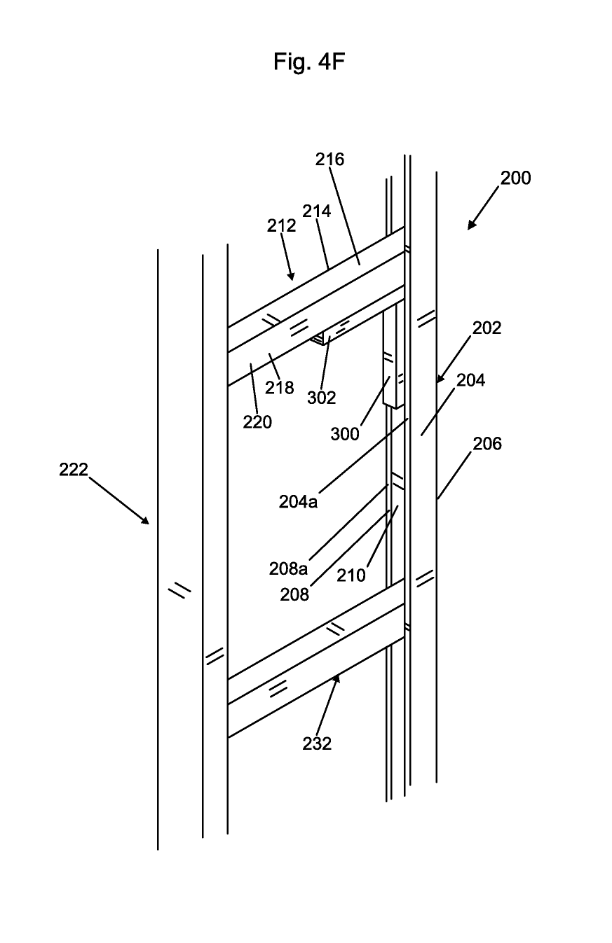

FIG. 4A shows a front, top, and left side perspective view of a ladder 200 for use with an embodiment of the present invention. FIG. 4B shows a top view of a post portion 202 of the ladder 200 of FIG. 4A. FIG. 4C shows a bottom view of a step portion 212 of the ladder 200 of FIG. 4A. FIG. 4D shows a top view of a first further insert 300 inserted into a gap 210 or recess of the post portion 202 of the ladder 200 of FIG. 4A. FIG. 4E shows a bottom view of a second further insert 302 inserted into a gap 220 or recess of the step portion 212 of the ladder 200 of FIG. 4A. FIG. 4F shows a front, top, and left side perspective view of the ladder 200 of FIG. 4A with the first further insert 300 and the second further insert 302 of FIGS. 4D and 4E respectively inserted and attached to the ladder 200 consistent with FIGS. 4D and 4E.

The ladder 200, shown in FIG. 4A, includes post portion 202 which has a U-shaped plate structure comprised of plates 204, 206, and 208 and gap or recess 210 as shown by FIGS. 4A and 4B. The ladder 200 further includes post portion 222 which may be a mirror image of the post portion 202, and may have an identical U-shaped plate structure. The ladder 200 further includes step portion 212 which has a U-shaped plate structure comprised of plates 214, 216, and 218 and gap or recess 220 as shown in FIG. 4C. The ladder further includes a step portion 232 which may be identical to the step portion 212 but located lower down the ladder 200. The step portions 212 and 232 may be connected to the post portions 202 and 222 by welding or in any other known manner. The ladder 200 may be a known ladder.

In accordance, with an embodiment of the present invention, the first further insert 300 may be inserted into the gap 210 and the second further insert 302 may be inserted in the gap 220 as shown by FIGS. 4D-4F. In at least one embodiment, the first further insert 300 and the second further insert 302 may be inserted by foam injecting into the gaps 210 and 220. The first and second further inserts 300 and 302 may be made of polyurethane rubber or foam rubber, or some other elastomeric material.

In at least one embodiment, the first further insert 300 and the second further insert 302 are inserted substantially at a right angle to each other. A plurality of further inserts may be inserted into each gap of each step portion and each gap of each post portion of a ladder, such as ladder 200, so that someone can carry the ladder on their shoulder without having a hard edge, such as a hard metal edge of the ladder hurt their shoulder.

In at least one embodiment, the first further insert 300 is inserted into the first gap 210 in a manner so that the first insert 300 protrudes out from the first gap 210, a distance as shown in FIG. 4D so that the insert 300 will rest on a person's should carrying the ladder 200, instead of the hard metal edges 208a and 204a. Similarly, the second insert 302 is inserted into the second gap 220 in a manner so that the second insert 302 protrudes out from the second gap 220 as shown in FIG. 4E, so that the insert 302 will rest on a person's shoulder carrying the ladder 200, instead of the hard metal edges 214a and 218a. A method in accordance with an embodiment of the present invention may include a person carrying either ladders 100 or 200 with the inserts 1 and/or 300, and 302 inserted and/or attached to the ladder 100 and/or 200, and the apparatus 1 and/or 300 and 302 contacting a shoulder of the person.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a device including
a first section which has a first slot; and
a second section having a second slot;
wherein the first section is attached to the second section so that the first section is substantially at a right angle with respect to the second section;
wherein the first slot and the second slot meet at a first junction;
and wherein the first section and the second section are made of an elastic material.

2. The apparatus of claim 1 further comprising
a ladder having first and second posts joined by a plurality of steps including a first step;
and wherein a part of the first step of the ladder fits into the first slot of the first section while at the same time a part of the first post fits into the second slot of the second section.

3. The apparatus of claim 1 wherein
the first and the second section are joined together at a second junction; and
wherein the second junction has an inner surface which is curved.

4. The apparatus of claim 1 wherein
the first and the second section are made of polyurethane rubber.

5. A method comprising:
attaching a first device to a ladder;
wherein the first device includes:
a first section which has a first slot; and
a second section having a second slot;
wherein the first section of the first device is attached to the second section of the first device so that the first section of the first device is substantially at a right angle with respect to the second section of the first device;
wherein the first slot and the second slot of the first device meet at a first junction of the first device;
and wherein the first section and the second section of the first device are made of an elastic material.

6. The method of claim 5 further comprising
attaching a second device to a ladder;
wherein the second device includes:
a first section which has a first slot; and
a second section having a second slot;
wherein the first section of the second device is attached to the second section of the second device so that the first section of the second device is substantially at a right angle with respect to the second section of the second device;
wherein the first slot of the second device and the second slot of the second device meet at a first junction of the second device;
and wherein the first section and the second section of the second device are made of an elastic material.

7. The method of claim 5 wherein
the ladder has first and second posts joined by a plurality of steps including a first step;
and wherein a part of the first step of the ladder fits into the first slot of the first section while at the same time a part of the first post fits into the second slot of the second section.

8. The method of claim 5 wherein
the first and the second section of the first device are joined together at a second junction of the first device; and
wherein the second junction of the first device has an inner surface which is curved.

9. The method of claim 5 wherein
the first and the second sections of the first device are made of polyurethane rubber.

10. A method comprising
inserting a first insert into a first gap between plates of a first post portion of a ladder;
inserting a second insert into a second gap between plates of a step portion of a ladder; and
wherein the first insert and the second insert are inserted substantially at a right angle to each other;
and wherein the first and the second inserts are made of an elastomeric material.

11. The method of claim 10 wherein
the first insert is inserted into the first gap in a manner so that the first insert protrudes out from the first gap; and
the second insert is inserted into the second gap in a manner so that the second insert protrudes out from the second gap.

12. The method of claim 11 further comprising
carrying the ladder with the first and second inserts inserted into the first and second gaps, respectively, so that the first and second inserts contact a shoulder of a person carrying the ladder.
